(19) United States
(12) Patent Application Publication
(10) Pub. No.: US 2026/0064736 A1
(43) Pub. Date: Mar. 5, 2026

(54) DATA RESOURCE IDENTIFICATION AND METRIC CALCULATION

(71) Applicant: Sage Global Services Limited, Newcastle Upon Tyne (GB)

(72) Inventors: Yu-Cheng Tsai, Redmond, WA (US); Ahmed Salhin, Edinburgh (GB); Todd Cook, Burlingame, CA (US); Josh Frazier, Frederick, MD (US)

(73) Assignee: Sage Global Services Limited, Newcastle Upon Tyne (GB)

(21) Appl. No.: 19/316,535

(22) Filed: Sep. 2, 2025

Related U.S. Application Data
(60) Provisional application No. 63/690,089, filed on Sep. 3, 2024.

(51) Int. Cl. G06F 16/3331; G06F 16/335; G06F 18/22

(52) U.S. Cl. CPC G06F 16/3331; G06F 16/335; G06F 18/22

(57) ABSTRACT

A computer implemented method for deriving a metric from a data resource. A data resource query is received from a user device and mapped to one or more data resources. Identifiers associated with mapped data resources are communicated to the user device. A mapping validation is received from the user device, representing a user validation of the mapping of data resources to the data resource query. A metric query is received from the user device and is similarly mapped to metrics with the mapping being validated by the user device. The validated mapped data resource and data defining how to compute the validated mapped metric are retrieved. A composite query including the metric definition data and the retrieved data resource and an instruction for an AI model to generate an instruction set for a deterministic function that applies the metric computation to the data resource are retrieved.

### TECHNICAL FIELD

The invention relates to techniques for deriving a metric from a data resource.

### BACKGROUND

In many business operation settings, it is common to produce standard data resources, for example standard accounting reports such as balance sheet reports, cash flow statements, income statements, and so on.

Unsurprisingly, in large or complex organisations, a great number of such standard data resources may exist, making them difficult to track manually. This presents a challenge when there is a requirement to analyse data from these data resources, for example to undertake business analytics operations, such as performance tracking and forecasting.

For example, a business operative such as an accountant, may be required to undertake a particular analytics task, for example to determine one or more metrics relating to the financial performance of certain parts of an organisation over a particular time period. Whilst the analytics task may be relatively straightforward, locating the relevant data resource may be time-consuming due to the number of data resources. This may be made more difficult still, if the format, organisation, and structure of the data resources are non-standard and unique to the organisation in question.

Recent advances in generative AI techniques offer the potential to drastically increase the speed and efficiency of undertaking business analytics tasks by automating certain data processing tasks. However, for accurate and reliable operation, the use of AI techniques to undertake analytics operations still typically require the correct underlying data (e.g. correct accounting data reports) on which the analytics tasks are to be performed to be manually identified.

### SUMMARY OF THE INVENTION

In accordance with a first aspect of the invention, there is provided a computer implemented method of deriving a metric from a data resource, said method comprising:
(a) receiving a first data resource query from a user device;
(b) determining if the first data resource query maps to one or more data resources of a plurality of data resources, and if so
(c) communicating identifiers associated with one or more mapped data resources to the user device;
(d) receiving from the user device a first mapping validation representing a user validation of the mapping of one of the one or more mapped data resources to the first data resource query from a user of the user device;
(e) receiving a second metric query from the user device;
(f) determining if the second metric query maps to a metric from a plurality of metrics, and if so;
(g) communicating an identifier associated with a mapped metric to the user device;
(h) receiving from the user device a second mapping validation representing a validation of the mapping of the mapped metric to the second metric query from a user of the user device;
(i) retrieving the validated mapped data resource;
(j) retrieving metric definition data defining how to compute the validated mapped metric;
(k) generating a composite query comprising the metric definition data and the retrieved data resource and an instruction for an AI model to generate an instruction set for a deterministic function that applies the metric computation to the data resource;
(l) inputting the composite query to the AI model and thereby obtaining the instruction set;
(m) inputting the instruction set to the deterministic function and obtaining an output, and
(n) communicating the output to the user device.

Optionally, step (b) comprises generating an embedding of the first data resource query; determining from a first plurality of embeddings, one or more of the first plurality of embeddings that match the embedding of the first data resource query, each embedding of the first plurality of embeddings derived from one of the plurality of data resources, and mapping to the first data resource query, one or more data resources of the plurality of data resources from which the one or more embeddings that match the embedding of the first data resource query are derived.

Optionally, step (f) comprises: generating an embedding of the second metric query; determining from a second plurality of embeddings, each embedding derived from data associated with a different one of the plurality of metrics, which of the second plurality of embeddings that most closely matches the embedding of the second metric query, and mapping the second metric query to the metric associated with the data from which the embedding that most closely matches the embedding of the second metric query was derived.

Optionally, the step of determining one or more of the first plurality of embeddings that match the embedding of the first data resource query comprises: determining which data-resource embeddings have a degree of similarity with the data-resource query embedding which exceeds a predetermined threshold similarity value, and matching the corresponding data resources with the first data resource query.

Optionally, the method comprises, prior to step (b): querying a validated mapping database to determine if the validated mapping database contains a record of a previously received data-resource query that matches the first data resource query, and that has previously been mapped to a data resource, and if so: retrieving the previously mapped data resource for use in step (k).

Optionally, the method comprises, prior to step (f): querying the validated mapping database to determine if the validated mapping database contains a record of a previously received metric query that matches the second metric query, and that has previously been mapped to a metric, and if so retrieving metric definition data defining how to compute the previously mapped metric for use in step (k).

Optionally, the method comprises, after step (c), writing validated mapping data to a validated mapping database indicative of the mapping of the first data resource query and the data resource.

Optionally, the method comprises, after step (f), writing validated mapping data to a validated mapping database indicative of the mapping of the second metric query and the metric.

Optionally, the method further comprises, prior to step (b): performing a first query qualification process in which the first data resource query is assessed to determine if it contains sufficient detail and clarity for processing, and if not: communicating a response back to the user device requesting clarification or additional information.

Optionally, the method further comprises, prior to step (f): performing a metric query qualification process in which the second metric query is assessed to determine if it contains sufficient detail and clarity for processing, and if not: communicating a response back to the user device requesting clarification or additional information.

Optionally, the instruction set obtained in step (l) comprises computer code that can be executed by a code execution module.

Optionally, the deterministic function is a code execution module that is configured to execute the computer code obtained from the instruction set.

In accordance with a second aspect of the invention, there is provided a computer system for deriving a metric from a data resource, said system comprising a metric computation system communicatively connected to a user device, said metric computation system configured to:
a) receive a first data resource query from the user device;
b) determine if the first data resource query maps to one or more data resources of a plurality of data resources, and if so
c) communicate identifiers associated with one or more mapped data resources to the user device;
d) receive from the user device a first mapping validation representing a user validation of the mapping of one of the one or more mapped data resources to the first data resource query from a user of the user device;
e) receive a second metric query from the user device;
f) determine if the second metric query maps to a metric from a plurality of metrics, and if so;
g) communicate an identifier associated with a mapped metric to the user device;
h) receive from the user device a second mapping validation representing a validation of the mapping of the mapped metric to the second metric query from a user of the user device;
i) retrieve the validated mapped data resource;
j) retrieve metric definition data defining how to compute the validated mapped metric;
k) generate a composite query comprising the metric definition data and the retrieved data resource and an instruction for an AI model to generate an instruction set for a deterministic function that applies the metric computation to the data resource;
l) input the composite query to the AI model and thereby obtain the instruction set;
m) input the instruction set to the deterministic function and obtain an output, and
n) communicate the output to the user device.

Optionally, to perform step b), the metric computation system is configured to:
generate an embedding of the first data resource query;
determine, from a first plurality of embeddings, one or more of the first plurality of embeddings that match the embedding of the first data resource query, each embedding of the first plurality of embeddings derived from one of the plurality of data resources, and
map to the first data resource query, one or more data resources of the plurality of data resources from which the one or more embeddings that match the embedding of the first data resource query are derived.

Optionally, to perform step (f), the metric computation system is configured to:
generate an embedding of the second metric query;
determine from a second plurality of embeddings, each embedding derived from data associated with a different one of the plurality of metrics, which of the second plurality of embeddings that most closely matches the embedding of the second metric query, and
map the second metric query to the metric associated with the data from which the embedding that most closely matches the embedding of the second metric query was derived.

Optionally, to determine one or more of the first plurality of embeddings that match the embedding of the first data resource query, the metric computation system is configured to: determine which data-resource embeddings have a degree of similarity with the data-resource query embedding which exceeds a predetermined threshold similarity value, and match the corresponding data resources with the first data resource query.

Optionally, prior to performing step (b), the metric computation system is configured to: query a validated mapping database to determine if the validated mapping database contains a record of a previously received data-resource query that matches the first data resource query, and that has previously been mapped to a data resource, and if so: retrieve the previously mapped data resource for use in step (k).

Optionally, prior to performing step (f), the metric computation system is configured to: query the validated mapping database to determine if the validated mapping database contains a record of a previously received metric query that matches the second metric query, and that has previously been mapped to a metric, and if so: retrieve metric definition data defining how to compute the previously mapped metric for use in step (k).

Optionally, after performing step (c), the metric computation system is configured to: write validated mapping data to a validated mapping database indicative of the mapping of the first data resource query and the data resource.

Optionally, after performing step (f), the metric computation system is configured to: write validated mapping data to a validated mapping database indicative of the mapping of the second metric query and the metric.

Optionally, prior to performing step (b), the metric computation system is configured to: perform a first query qualification process in which the first data resource query is assessed to determine if it contains sufficient detail and clarity for processing, and if not: communicate a response back to the user device requesting clarification or additional information.

Optionally, prior to performing step (f): the metric computation system is configured to: perform a metric query qualification process in which the second metric query is assessed to determine if it contains sufficient detail and clarity for processing, and if not: communicate a response back to the user device requesting clarification or additional information.

Optionally, the instruction set obtained in step (l) comprises computer code that can be executed by a code execution module.

Optionally, the deterministic function is a code execution module that is configured to execute the computer code obtained from the instruction set.

The invention provides a technique that enables a user (e.g. an accountant or other financial expert) who may have expertise but not detailed knowledge of a body of data resources, to guide the selection of an appropriate data resource and then the selection of an appropriate metric to derive from the data resource. To achieve this, the system suggests relevant data resources and metrics based on user queries (typically in natural language) and validates them with the user feedback. Once the user validates the data resource and metric, the system uses an AI model to generate an instruction set for a deterministic function that applies the metric to the data resource. This is accomplished by generating a composite query for input to the AI model which comprises the relevant data resource and metric definition data defining the relevant metric, and an instruction for the AI system to generate an instruction set for the deterministic function.

The technique is advantageous in that it improves the workflow of a user who may have expertise but not detailed knowledge of a body of data resources. The user can use natural language queries to guide the selection of the relevant data resource and metric, without having to search for or recall specific data resources or metrics from a large and complex data collection.

Moreover, by using the AI model to generate an instruction set for a deterministic function, rather than just passing both the data resource and metric through an LLM, the technique reduces the chances of unreliable or hallucinated results that may otherwise arise from a purely generative AI system.

In certain examples, the instruction set may be computer code generated by the AI model in a programming language which the deterministic function is configured to process. In such examples, the deterministic function may be a code execution module that interprets or compiles and executes the instruction set.

Various further features and aspects of the invention are defined in the claims.

### BRIEF DESCRIPTION OF THE DRAWINGS

Embodiments of the present invention will now be described by way of example only with reference to the accompanying drawings where like parts are provided with corresponding reference numerals and in which:

FIG. 1 provides a simplified schematic diagram depicting a system arranging accordance with certain embodiments of the invention;

FIG. 2 provides a diagram depicting a user interaction with a chat bot in accordance with an illustrative example of the invention;

FIG. 3 provides a simplified schematic depicting a simplified schematic diagram of a system for generating embeddings in accordance with certain embodiments of the invention;

FIG. 4 provides a flow diagram depicting operation of the system shown in FIG. 3;

FIG. 5 provides a flow diagram depicting operation of the system shown in FIG. 1, and

FIG. 6 provides a simplified schematic diagram depicting an example implementation of the system depicted in FIG. 1.

### DETAILED DESCRIPTION

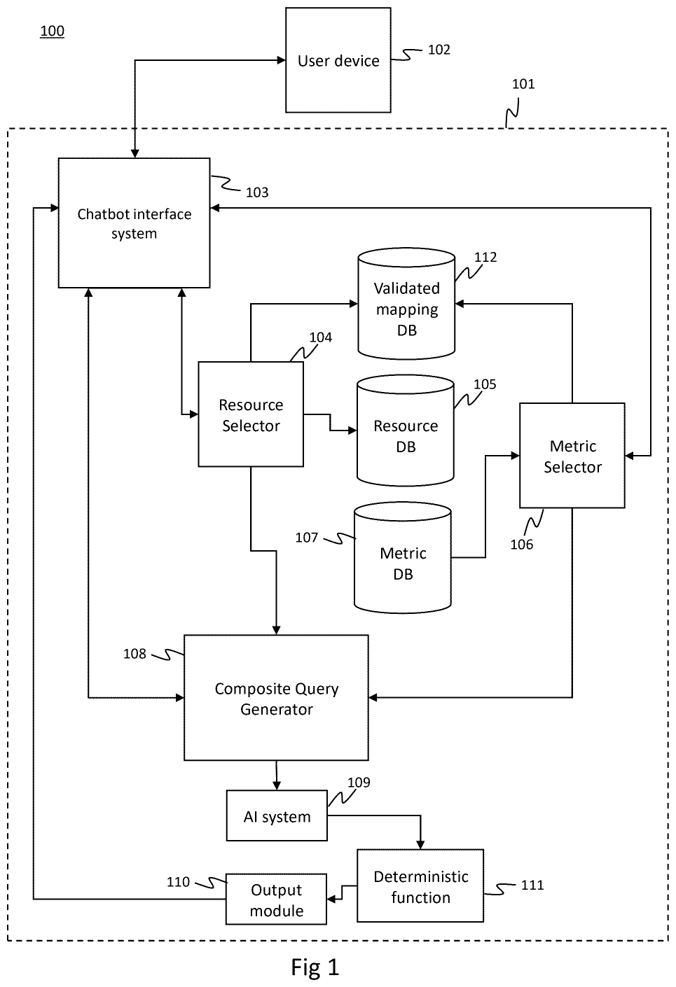

FIG. 1 provides a simplified schematic diagram depicting a system 100 for implementing a user-guided technique for deriving a metric from a data resource in accordance with certain embodiments of the invention.

The system comprises a metric computation system 101 communicatively connected to a user device 102. The metric computation system 101 comprises an interface system 103 for communicating data and from a user of the user device 102 via an interface of the user device 102. The interface system 103 implements a chatbot-type interface.

Such a chatbot interface, is typically accessed through a web interface on the user device 102 and enables interactive communication with the user. The interface allows users to input queries, to which the chatbot interface system 103 responds dynamically. Typically, such a chatbot is implemented using advanced natural language processing techniques, for example based on state-of-the-art chatbot systems, such as OpenAI's GPT-4, Google Cloud Dialogflow, Anthropic's conversational models, Microsoft Azure Bot Service, IBM Watson Assistant, and HuggingChat from Hugging Face. As is known, these systems comprise machine learning models that interpret and generate human-like responses based on the user's input.

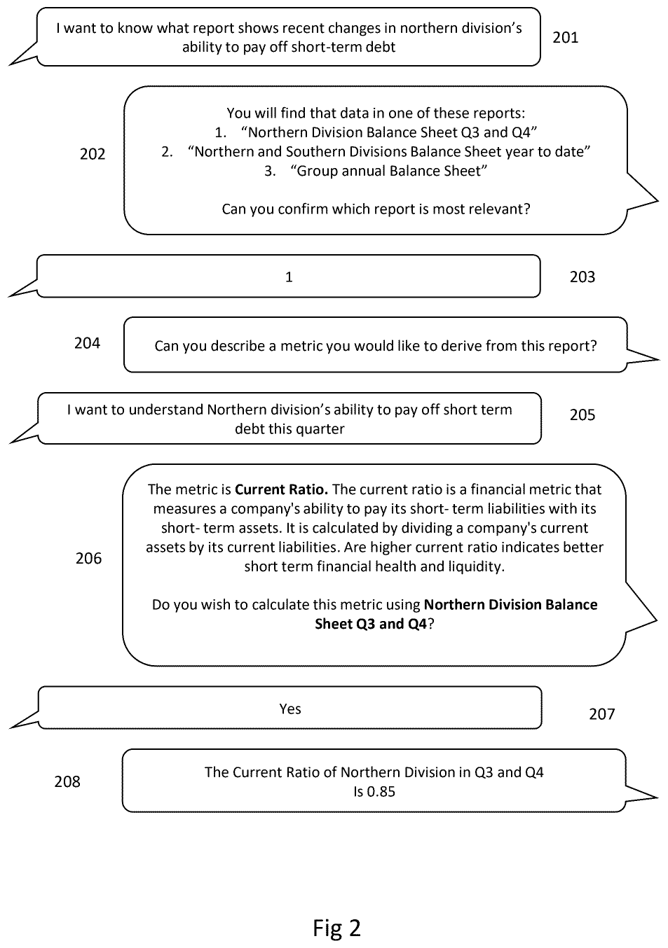

As described in more detail below, FIG. 2 provides a diagram depicting an illustrative example of a user interaction with the chatbot interface system 103.

The metric computation system 101 comprises a data resource selector module 104 which is connected to the chatbot interface system 103. The metric computation system 101 further comprises a data resource selector module 104, data resource database 105, metric selector module 106 and metric database 107. The data resource selector module 104 is connected to the data resource database 105. The chatbot interface system 103 is further connected to the metric selector module 106 which in turn is connected to the metric database 107.

As described in more detail below, typically, the data resource database 105 has stored therein a plurality of data resources, a corresponding plurality of data resource identifiers, and a plurality of data resource embeddings. Each data resource is associated with one specific data resource identifier and one specific data resource embedding.

The metric database 107 has stored therein metric definition data defining a plurality of different metric computations, a corresponding plurality of metric identifiers, and a plurality of metric embeddings. Each metric identifier and metric embedding is associated with a corresponding metric computation.

The metric computation system 101 further comprises a composite query generator 108.

The chatbot interface system 103, data resource selector module 104 and data resource database 105 are connected to the composite query generator 108. The metric computation system 101 further comprises an AI system 109 to which the composite query generator 108 is connected. The AI system 109 is typically provided by a system for passing queries to, and receiving outputs from an AI model, for example a system which implements a generative AI model such as a large language model (LLM). The AI system 109 may incorporate an LLM system itself or include an interface for interacting with an externally implemented LLM system.

The metric computation system 101 further comprises a validated mapping database 112. As is explained in more detail below, the validated mapping database 112 has stored therein data indicative of a number of previously validated mappings between data-resource user queries and data resources, and previously validated mappings between metric queries and metrics. The data resource selector module 104 and metric selector module 106 are further connected to the validated mapping database 112.

The metric computation system 101 further comprises a deterministic function 111 and a output module 110. The deterministic function 111 is connected to the AI system 109 and the output module 110. The output module 110 is further connected to the chatbot interface system 103.

In use, a user inputs a data-resource query to the chatbot interface system 103, which is typically a natural language query seeking to identify a relevant data resource.

In the context of examples of the invention, ‘data resources’ refer to various types of informational content that, in a given setting, a user may wish to be queried and retrieved, and from which a metric can be derived. As the skilled person will understand, data resources can be in any suitable format, for example, text files such as PDFs, DOCX files, or spreadsheets (e.g., XLSX files). Additionally, these resources may include but are not limited to presentations (e.g., PPTX files), digital media formats, or any other data structure capable of storing and presenting information as needed by a user.

In certain examples, the data resources in question may be financial and accounting report data resources, such as profit and loss statements, balance sheets, cash flow statements, accounts receivable aging reports, budget vs. actual reports, inventory reports, and so on. For larger or more complex organisations, these data resources reports might relate to specific time periods, such as quarters, and/or to specific parts of the organisation. For example, a profit and loss statement might show the revenue and expenses of a certain department or region for the last six months, or a cash flow statement might show the inflows and outflows of cash for the whole company for the current year.

In such instances, a data-resource query may be a request from a user to identify the most relevant accounting report relating to a particular task, for example:
“I want to know what accounting report shows recent changes in Northern Division's ability to pay off short-term debt.”

Such a data-resource query is depicted as a first user input 201 shown in FIG. 2.

In certain examples, the chatbot interface system 103 is then configured to perform a first query qualification process in which the data-resource query provided by the user is assessed to determine if it contains sufficient detail and clarity for processing.

This can be achieved in any suitable way. For example, the chatbot interface system 103 can implement the first query qualification process by using a language model (LLM) that can evaluate the data-resource query and assign a classification to it based on how well it matches the expected format and content of a valid query. For example, the chatbot interface system 103 could send the data-resource query to an LLM along with a prompt such as, “Is this query sufficiently detailed and clear for further processing? (yes/no)” and then receive a response from the LLM indicating whether the query meets the criteria or not. If the response is “yes”, the query is passed to the data resource selector module 104; if the response is “no”, the chatbot interface system 103 may be configured to send a response back to the user device 102 requesting clarification or additional information.

For example, a user might input a query such as, “I need a report on financial performance,” which does not provide enough context to accurately identify the relevant data resource. The chatbot interface system 103 could then present a follow-up question like, “Which division's financial performance are you interested in?”or “Are you looking for a specific time period or type of financial report?”.

As will be understood, the chatbot interface system 103 can implement the process of requesting further information from the user in any suitable way. For example, the interface could be configured with a dynamic decision tree that guides the user through a series of questions based on their initial query. Additionally, all alternatively, the chatbot interface system 103 might also employ a feedback loop, learning from past interactions to improve its query qualification process over time.

As mentioned above, if the query qualification process determines the data-resource query does contain sufficient detail and clarity for processing, or once the user has been prompted to provide a query with sufficient detail and clarity, the data-resource query is then passed to the data resource selector module 104.

In certain examples, on receipt of the data-resource query, the data resource selector module 104 is configured to query the validated mapping database 112 to determine if it contains a record of a previously received data-resource query matching the currently received data-resource query and to which a data-resource has previously successfully been mapped.

If this is the case, a relevant data resource identifier is returned from the validated mapping database 112 to the data resource selector module 104 and this data resource identifier associated with the previously mapped data resource is presented to the user via the chatbot interface system 103 for review. The user is typically prompted to validate that this is an appropriate mapping of a data resource to the current data-resource query. If such a validation is received from the user, the user is then prompted to provide a metric query as described in more detail below.

However, if the user rejects the previously mapped data resource, or if query of the validated mapping database 112 by the data resource selector module 104 does not result in a previous mapping of a data-resource query to a data resource (implying the query has not previously been encountered), the data resource selector module 104 is configured to generate an embedding of the data-resource query using a first embedding model.

As is known in the art, an embedding model is configured to perform a process whereby data, such as text data, is converted into a vector space. This vector space is typically generated during a machine learning training process so that the semantic meaning of the data is captured and represented numerically. Three common ways to create text embedding include: using a pre-trained Transformers (e.g. BERT or GPTs), Sentence Transformers, or Term Frequency-Inverse Document Frequency.

Once generated, the data resource selector module 104 then compares this data-resource query embedding with the plurality of data-resource embeddings stored in the data resource database 105. Each of these are embeddings of data resources that have been previously generated, using the first embedding model.

Using an appropriate technique, for example cosine similarity, the data resource selector module 104 maps one or more data resources stored within the data resource database 105 to the data-resource query by determining which of the data-resource embeddings are a match with the data-resource query embedding.

As the skilled person will understand, in this context, a ‘match’ refers to a data-resource embedding that is sufficiently close in the embedding vector space to imply that the corresponding data-resource is relevant to the data-resource query.

Typically, to determine which data-resource embeddings match the data-resource query embedding, the degree of similarity of each data-resource embedding with the data-resource query embedding (typically a numerical degree of similarity calculated as noted above using a suitable technique such as cosine similarity), is compared with a predetermined threshold similarity value. Data-resource embeddings with a degree of similarity to the data-resource query embedding that exceed the predetermined threshold similarity value are identified as a match. The predetermined threshold similarity value can be selected in any suitable way. For example, it can be empirically selected to strike a balance between excluding irrelevant data resources and avoiding excluding relevant data resources.

If multiple data resources are mapped to the data-resource query, the data resource selector module 104 then typically performs a ranking process in which the data resources mapped to the data resource query are ranked by similarity. If greater than a predetermined number of data-resources have been mapped to the data resource query, the ranking process can identify the most similar, e.g. the top five data resources.

The data resource selector module 104 then retrieves from the data resource database 105 an identifier associated with each of the mapped and ranked data resources and returns these identifiers to the chatbot interface system 103. The identifiers can be any suitable identifier that enable a user of the user device 102 to review the data resource in question. For example, file names, document titles, metadata tags, content summaries, snippets of content, and so on.

These identifiers are then presented to the user via the chatbot interface system 103. An example is depicted as a first chatbot output 202 shown in FIG. 2.

Typically, the chatbot interface system 103 then prompts the user of the user device 102 to validate the mapping of one of the data resources to the user's original data-resource query. In other words, the user identifies which data resource is relevant to their data resource query.

Typically, this involves the user providing selection information selecting one of the mapped data resources confirming that the selected data resource is relevant to the original data-resource query. An example of this is depicted as a second user input 203 shown in FIG. 2.

If none of the options provided is relevant to the original data resource query, the user can modify, via the chatbot interface system 103, the original data resource query to provide further context based on the output in 202. Typically, this qualification process will generate a new round of ranked results for the user to validate.

Once a mapping validation validating the mapping of one of the data resources has been obtained from the user, the user is then prompted to provide a metric query relating to a metric that a user wishes to derive from the data of the selected data resource. An example of such a prompt is depicted as a second chatbot output 204 shown in FIG. 2.

In the context of examples of the invention, a ‘metric’ refers to any suitable type of quantitative or qualitative measure that can be derived from a data resource. Just as data resources can encompass a wide range of informational content, metrics derived therefrom can vary significantly depending on the specific requirements and objectives of the user.

In certain examples, particularly where the data resources relate to accounting report data resources, such as those noted above, the metric query may relate to financial metrics such as current ratio, debt-to-equity ratio, return on equity, gross profit margin, net profit margin, and so on.

Thus, where the data resources in question are data resources such as accounting report data resources, like profit and loss statements, balance sheets, cash flow statements, accounts receivable aging reports, budget vs. actual reports, and inventory reports, the metric query may be a request to identify the metric calculation necessary to derive an accounting metric, such as:
“i want to understand Northern division's ability to pay off short term debt this quarter”

Such a user query is depicted as a third user input 205 shown in FIG. 2.

The chatbot interface system 103 is configured to perform a second query qualification process in which the metric query provided by the user is assessed to determine that it contains sufficient detail and clarity for processing.

The second query qualification process can be implemented in a corresponding way to the first query qualification process as described above.

If the second metric query qualification process determines that the metric query does not contain sufficient detail and clarity for processing, the chatbot interface system 103 sends a response back to the user device 102 requesting clarification or additional information.

However, if the second metric query qualification process determines that the metric query does contain sufficient detail and clarity for processing, or once sufficient additional detail has been provided by the user, the metric query is then passed to the metric selector module 106.

In certain examples, on receipt of the metric query, the metric selector module 106 is configured to query the validated mapping database 112 to determine if it contains a record of a previously received metric query matching the currently received metric query and to which a metric has previously successfully been mapped.

If this is the case, a relevant metric identifier is returned from the validated mapping database 112 to the metric selector module 106 and this metric identifier associated with the previously mapped metric is presented to the user via the chatbot interface system 103 for review.

The user is then typically prompted to validate that this is an appropriate mapping of a metric to the current metric query. If such a validation is received from the user, the chatbot interface system 103 passes the data resource identifier for the validated data resource and the metric identifier for the validated metric to the composite query generator 108 as described below.

However, if the user rejects the previously mapped metric, or if query of the validated mapping database 112 by the metric selector module 106 does not result in a previous mapping of a metric query to a metric, the metric selector module 106 is configured to generate a metric query embedding of the metric query using a second embedding model.

The metric selector module 106 then compares this metric query embedding with a plurality of metric embeddings stored in the metric database 107. Each metric embedding represents a metric in embedding vector space and as described in more detail below, each metric embedding is derived from data associated one of the plurality of metrics, for example metric definition data defining the nature of the metric and in particular the computations necessary to compute the metric from suitable resource data.

Using an appropriate technique, for example cosine similarity, the metric selector module 106 maps a metric to the metric query by determining which metric embedding of the plurality of metric embeddings most closely matches the metric query embedding.

The metric selector module 106 then retrieves from the metric database 107 a metric identifier associated with the mapped metric and returns this metric identifier to the chatbot interface system 103.

The metric identifier can be any appropriate identifier, which suitable identifies the metric to the user, for example one or more of: a descriptive summary of the metric, a metric name, a metric equation or equations, a descriptive label, graphical representation and so on.

The chatbot interface system 103 then prompts the user of the user device 102 to validate the mapping of the metric to the user's original metric query, for example by asking if the user wishes to derive the metric from the data resource. An example of the display of a metric identifier and a prompt to validate the mapping of the metric to the user's metric query is depicted as a third chatbot output 206 shown in FIG. 2.

The user then validates the mapping of the metric to the user's original metric computation query, for example by confirming that they do wish to derive the metric from the data resource. An example of this is depicted as a fourth user input 207 shown in FIG. 2.

Once both the mapping of the data resource and the mapping of the metric computation have been validated by the user, the chatbot interface system 103 passes the data resource identifier for the validated data resource and the metric identifier for the validated metric to the composite query generator 108.

The composite query generator 108 is then configured to retrieve (either directly or via the data resource selector module 104) the data resource from the data resource database 105 associated with the data resource identifier, and retrieve (either directly or via the metric selector module 106) from the metric database 107, the metric definition data associated with the metric identified by the metric identifier for deriving the metric from the data resource (for example, equations and algorithms necessary for the relevant metric computations to be performed).

Using the retrieved data resource and retrieved metric definition data, the composite query generator 108 is then configured to generate a composite query comprising an instruction for an AI model to generate an instruction set for input to a deterministic function to derive the metric from data of the data resource.

For Example:
“Based on the following data extracted from the following report titled “Northern Division Balance Sheet Q3 and Q4” <report content inserted here>, please find the lines of current assets and the current liabilities. Please use the definition of “Current Ratio” <current ratio definition here>. Please generate a python script that can be complied to compute “Current Ratio”.”

As the skilled person will understand, the composite query generator 108 can generate the composite query in any suitable way. For example, the query itself could be generated by using an AI model like an LLM. For example, the composite query generator might use an LLM to generate the composite query by providing it with the metric definition data and the data resource as inputs, and providing a query to produce the composite query. For example, an instruction to produce a natural language instruction for an AI model to generate an instruction set for a deterministic function to apply the metric to the data of the data resource.

For Example:
“Using appropriate data from this data resource <data resource inserted here>, generate a prompt for a generative AI system to write an <instruction set type> for a <deterministic function type> to derive the metric defined as follows: <metric definition data inserted here>”

As the skilled person will understand, alternative techniques could be used to generate the composite query, for example rule-based methods, template-based methods, or hybrid methods that combine different techniques.

Once generated, the composite query generator 108 then passes the composite query to the AI system 109. The AI system 109 then passes the composite query through the AI model which generates an output comprising an appropriate instruction set to apply the metric computation to the data resource. For example, computer code such as a python script to compute the “Current Ratio”.

This instruction set is then passed to the deterministic function 111.

Typically, the instruction set is some form of script or code, and the deterministic function is provided by a code execution module for interpreting and executing the code or script. For example, if the instruction set is a Python script, the deterministic function could be a Python interpreter, such as CPython, which reads and executes the Python script directly. Alternatively, the instruction set could be JavaScript, and the corresponding deterministic function could be a JavaScript engine. The instruction set could be a formula or series of formulas, with the deterministic function being a calculation engine that processes and computes results based on the provided formulas.

In an example in which the output instruction set is computer code such as a Python script, the deterministic function would be a code execution function which compiles and executes the Python script of the instruction set, generates an output (for example the computed Current Ratio value) and communicates this to the output module 110.

Assuming successful execution, the output from the deterministic function comprises an “answer” in which the metric in question has been derived from the data of the data resource.

The output from the deterministic function is then passed to the output module 110, which will typically apply a suitable output review function to the output.

The output review function reviews the output from the deterministic function to verify its suitability. For example, the output review function may be configured to assess the output for one or more of: relevance, (ensuring the output directly relates to the initial query); completeness (making sure all aspects of the query are addressed); consistency (checking for any internal contradictions); redundancy (removing repetitive information); sensitivity (ensuring the content is free from inappropriate or biased statements); and compliance (verifying adherence to applicable industry regulations and standards).

The output review function can be implemented in any suitable way. In one example, the output review function might be implemented by passing the output from the AI system 109 through a suitable checking model based on an LLM.

Assuming, the output module 110 verifies that the output is suitable, and no errors are detected, the output is presented to the user on the chatbot interface system 103. An example is depicted as a final chatbot output 208 shown in FIG. 2.

### Updating the Validated Mapping Database 112

As mentioned above, the validated mapping database 112 has stored therein data indicative of a number of previously validated mappings between data-resource user queries and data resources, and previously validated mappings between metric queries and metrics.

In order to continually supplement this data, in certain embodiments whenever the data resource selector module 104 receives a mapping validation validating the mapping of a data resource to a data-resource query (for example the second user input 203 as shown in FIG. 2), the data resource selector module 104 is configured to write validated data-resource mapping data to the validated mapping database 112 which is indicative of this validated mapping.

Similarly, in certain embodiments whenever the metric selector module 106 receives a mapping validation validating the mapping of a metric to a metric query (for example, the fourth user input 207 shown in FIG. 2), the metric selector module 106 is configured to write validated metric mapping data to the validated mapping database 112 which is indicative of this validated mapping.

### Training of First Embedding Model

As described above, the data resource selector module 104 employs a first embedding model to generate data-resource query embeddings. In typical embodiments, this is the same embedding model which is used to generate the plurality of data resource embeddings stored in the data resource database 105. In this way, the data-resource query and data resource can be compared in an identical vector space.

Whilst in certain instances, the first embedding model may be a generic embedding model, in certain examples, the first embedding model is trained for a specific domain. Specifically, the first embedding model is trained to optimise its ability to match user queries relating to data resource of a particular domain with data resources belonging to that particular domain.

For example, the first embedding model can be optimised to match data resource queries relating to accounting reports to data resources comprising accounting reports. Further still, optimisation of the first embedding model can be targeted more specifically. For example, the first embedding model can be optimised to match data resource queries relating to accounting reports of a particular organisation to data resources comprising accounting reports from that organisation.

In such examples, the first embedding model is subject to special training to optimise it for use in the relevant domain.

This can be undertaken in any suitable way, for example, a corpus of training data can be used comprising text of example/representative user data resource queries, and text from data resources from the relevant domain. This training data is then used to fine-tune the vector space of a generic embedding model or, if resources permit, create the vector space of an entirely bespoke embedding model from scratch.

In keeping with the first model, and as described above, the metric selector module 106 employs a second embedding model to generate metric query embeddings. In typical embodiments, this is the same embedding model which is used to generate the plurality of metric embeddings stored in the metric database 107. In this way, the metric user query and metric computation can be compared in the identical vector space.

In certain instances, the second embedding model may be a generic embedding model and/or simply the first embedding model can be used. However, in certain examples, and in keeping with the first embedding model, the second embedding model can be trained to optimise its ability to match user metric queries relating to queries from a particular domain with metrics belonging to that particular domain, such as accounting, for example.

This can be undertaken in any suitable way, for example by fine-tuning the vector space of a generic embedding model to represent domain-specific metric definitions for answering domain-specific metric-related questions, or, if resources permit, to create the vector space of an entirely bespoke embedding model from scratch.

As mentioned above, before use of the system, in typical embodiments, the first embedding model is used to generate data-resource embeddings of the data resources which are then stored in the data resource database 105 for comparison with data-resource query embeddings generated by the data resource selector module 104.

Similarly, as mentioned above, before use of the system, in typical embodiments, the second embedding model is used to generate metric embeddings to represent the metrics associated with the metric definition data stored in the metric database 107 which are then stored in the metric database 107 for comparison with the metric query embedding generated by the metric selector module 106.

To generate each data-resource embedding, each data resource is first “chunked” in accordance with a suitable chunking strategy. Each chunk is then subject to pre-embedding processing and tokenizing. Subsequently, each processed and tokenized chunk is then passed through the first embedding model to generate a vectorised embedding output (the data resource embedding).

Typical chunking strategies comprise dividing the tokenized text into meaningful segments or chunks. These chunks might be sentences, paragraphs, or specific thematic sections.

In examples where the technique is used for a specific domain, aspects of the pre-embedding processing for generating the data resource embeddings and/or aspects of the pre-embedding processing for generating the metric computation embeddings can be tested to determine which yield optimal results.

For example, an optimal chunking strategy for both data resource embeddings and metric embeddings can be determined empirically.

For example, for a given domain such as financial accounting, data resource embeddings generated using chunking by sections; chunking by headers; chunking every 100 words; chunking every page, etc, can each be tested relative to each other to determine which produce embeddings which yield the most accurate/appropriate matching of data resources to data resource queries. As will be understood, the same approach can be taken to identify the optimum chunking strategy for generating metric computation embeddings.

Likewise, to generate each metric embedding, metric definition data is subject to chunking, pre-embedding processing and tokenizing and then each processed and tokenized chunk is passed through the second embedding model to generate a vectorised embedding output.

In this case, metric definition data is data that defines, in some suitable manner, the nature of the computations necessary to compute the metric from a suitable resource data. This metric definition data may include elements such as mathematical formulas and algorithms used for metric computation, key variables and their sources, and examples of typical values or outputs. The metric definition data may further comprise a qualitative description of the metric's purpose and relevance in decision-making, and examples of how the metric is applied in real-world scenarios. In certain examples, the metric definition data may be derived from information sources such as domain specific text books, guidelines, manuals or similar resources. For example, for accounting metrics, such information sources may include financial text books and accounting standards documentation.

As is known, pre-embedding processing typically comprises steps such as converting all text to a uniform case, removing unnecessary punctuation and stop words. “Tokenizing” comprises dividing the remaining text into a sequence of individual “tokens”, e.g. words or sub-words.

The pre-embedding processing may also involve a terminology standardising process in which acronyms are expanded (e.g., converting “COGS”—Cost of Goods Sold) and abbreviations replaced with their standard equivalents (e.g. replacing “Inv. No.” with “Invoice Number”, or replacing “Curr.” with “Currency”).

In certain examples, the pre-embedding processing can comprise a summarisation stage in which a data resource or metric computation summary is generated and then inserted into the data resource or metric definition data before the data is subject to the pre-embedding processing. Such a summary can be generated in any suitable way, for example manually or by some or all of the content of the data resource or metric definition data being passed through an LLM with an instruction to generate an appropriate summary.

Whether this generation and insertion of a data resource or metric summary improves the performance of the technique can be determining empirically by testing whether embeddings generated from data resources and metric definition data including such summary data or absent such summary data yield the most accurate/appropriate matching of data resources to data resource queries.

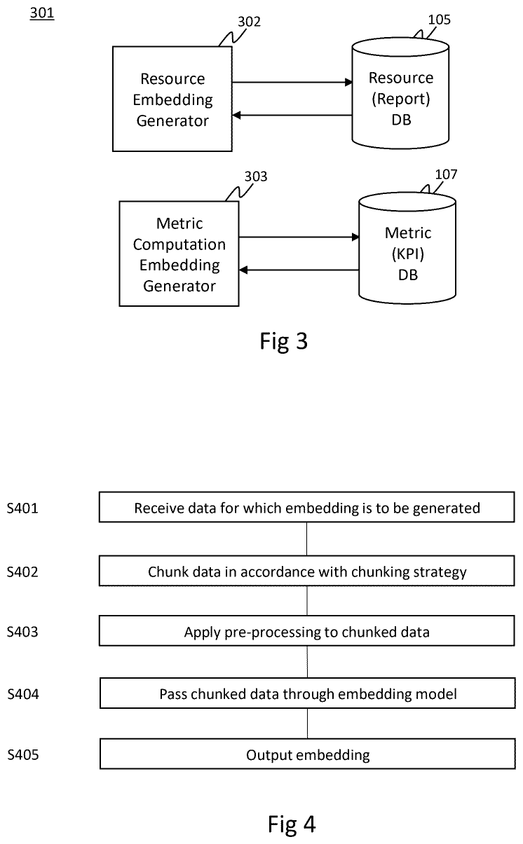

FIG. 3 provides a simplified schematic diagram depicting an example of a system for generating data resource embeddings and metric embeddings as described above.

The system comprises a resource embedding generator 302 which is connected to the data resource database 105, and a metric embedding generator 303 which is connected to the metric database 107.

In use, the resource embedding generator 302 is configured to retrieve a data resource from the data resource database 105, perform an embedding generation process on the data resource to generate a data resource embedding, and then communicate this data resource embedding back to the data resource database 105 where it is stored for use as described above with reference to FIG. 1.

Similarly, in use, the metric embedding generator 303 is configured to retrieve metric definition data from the data resource database 105, perform an embedding generation process on the metric definition data to generate a metric embedding, and then communicate this metric embedding back to the metric database 107, where it is stored for use as described above with reference to FIG. 1.

FIG. 4 provides a flow diagram showing the steps of an embedding generation process performed by the resource embedding generator 302 and metric computation embedding generator 303 to generate embeddings.

At the first step S401, the data of which an embedding is to be generated is received, i.e. a data resource or metric definition data. At a second step S402, this data is then chunked in accordance with a chunking strategy. At a third step S403, the chunked data is pre-processed and tokenized, and at a fourth step S404, the chunked pre-processed data is passed through the embedding model. At a fifth step S405, the embedding generated by the embedding model is output.

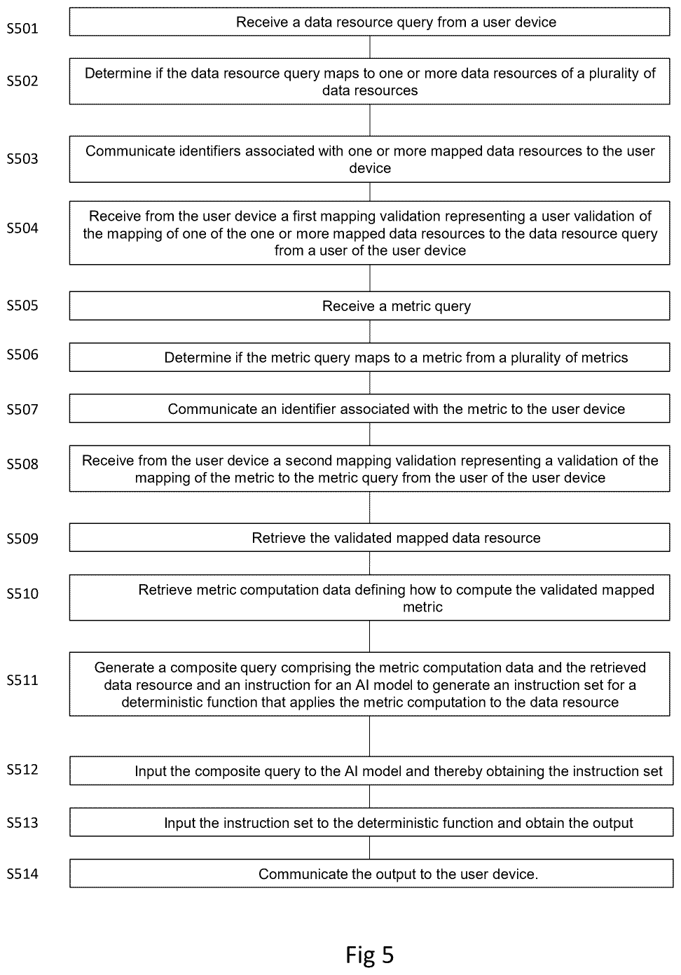

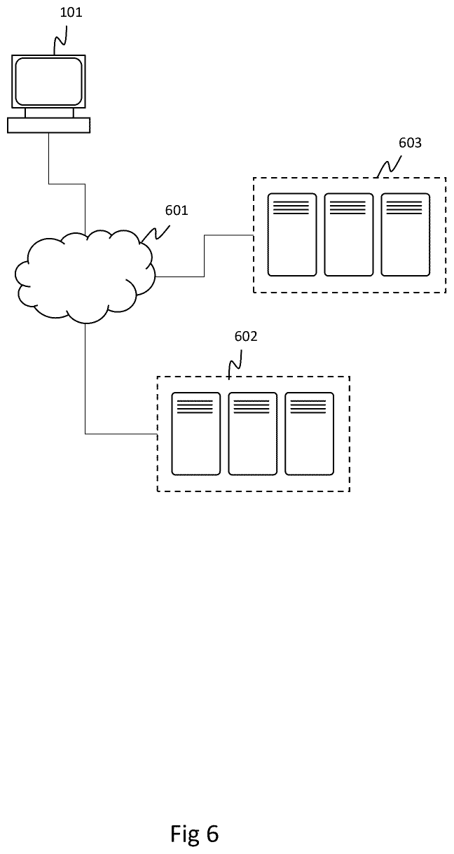

FIG. 5 provides a diagram depicting a computer implemented process for deriving a metric from a data resource in accordance with examples of the invention, such as the example described above.

At a first step S501 a first data resource query is received from a user device which is typically a natural language query seeking to identify a relevant data resource. As described above, at this stage in certain embodiments, a query qualification process is performed in which the data-resource query provided by the user is assessed to determine if it contains sufficient detail and clarity for processing.

Further, as described above, in certain embodiments, at this stage, a validated mapping database is queried to determine if a record of a previously received and mapped data-resource query that matches the first data resource query exists, and if so, the previously mapped data resource is retrieved for use in the eleventh step S511 described below.

Unless further information is required from the user or a previously received and mapped data-resource query is identified, at a second step S502, it is determined if the first data resource query maps to one or more data resources of a plurality of data resources. As described above, this is typically achieved by generating and matching embeddings of the user query and the data resources to map the query to one or more data resources. If multiple data resources are identified, they can be ranked by relevance.

At a third step S503, identifiers associated with the mapped data resources are then communicated to the user device. If multiple data resources are identified they are presented to the user, for example in ranked order.

At a fourth step S504, a first mapping validation representing a user validation of the mapping of one of the mapped data resources is received from the user device. As described above, in certain embodiments, a validated mapping of the data resource to the first data resource query is then stored in a database to supplement existing data.

As described above, at this stage in certain embodiments, a query qualification process is performed in which the metric query provided by the user is assessed to determine if it contains sufficient detail and clarity for processing. Assuming that this is the case, and further information is not required from the user, at a fifth step S505, a second metric query is received from the user device which is typically a natural language query seeking to identify a metric which a user of the user device wishes to apply to the data resource.

Further, as described above, in certain embodiments, at this stage, the validated mapping database is queried to determine if a record of a previously received and mapped metric query that matches the second metric query exists, and if so, data associated with the previously mapped metric is retrieved for use in the eleventh step S511 described below.

At a sixth step S506, it is determined if the second metric query maps to a metric from a plurality of metrics. As described above, this is typically achieved by generating and comparing embeddings of the second metric query and embedding derived from data associated with the plurality of metrics to map the query to the most relevant metric.

At a seventh step S507, an identifier associated with the mapped metric is communicated to the user device.

At an eighth step S508, a second mapping validation representing a validation of the mapping of the metric to the second metric query from a user of the user device is received from the user device. As described above, in certain embodiments, a validated mapping of the metric to the second metric query is then stored in a database to supplement existing data.

At a ninth step S509, the validated mapped data resource is retrieved.

At a tenth step S510, metric definition data defining how to compute the validated mapped metric is retrieved.

At an eleventh step S511, a composite query comprising the metric definition data and the retrieved data resource and an instruction for an AI model to generate an instruction set for a deterministic function that applies the metric computation to the data resource is generated.

At a twelfth step S512 the composite query is input to the AI model and an instruction set is thereby obtained.

At a thirteenth step S513, the instruction set is input to the deterministic function and an output obtained.

At a fourteenth step S514, the output is communicated to the user device.

As the skilled person will understand, examples of the invention can be realised in any suitable way, adapted as appropriate in dependence on the setting in which the invention is implemented.

FIG. 6 provides a simplified schematic diagram depicting an example implementation of the invention described with reference to FIG. 1 and for implementing a process as described with reference to FIG. 5. In this example, the user of the user device 102 may be a financial specialist, such as an accountant, who is accessing accounting and financial software services provided by a platform hosted on a computer system and the metric computation system 101 is incorporated in the service platform.

The user device 102 is connected by a data network 601 provided for example by the Internet, to a computer system 602 hosting a service platform that provides accounting and financial software services to a user of the user device 101. The user device 102 can be any suitable user device including but not limited to a desktop computer, laptop, tablet, smartphone, wearable device, or any smart device capable of connecting to the internet. Although not shown for clarity, the user device 102 is typically one of a plurality of user devices accessing the services provided by the computer system 602.

The computer system 602 typically comprises a combination of servers for processing data, storage systems for data retention, and networking components to facilitate connectivity and data exchange.

This system is engineered to host and execute the software necessary for delivering accounting and financial services, supporting scalable user access and secure data management.

The computer system 602 has running thereon software which implements the metric computation system 101 including the chatbot interface system 103, data resource selector module 104, metric selector module 106, composite query generator 108, AI system 109, deterministic function 111, and output module 110. In certain examples, the computer system 602 has running thereon software for implementing the resource embedding generator 302 and metric embedding generator 303 described with reference to FIG. 3.

The computer system 602 further has storage systems for implementing the data resource database 105, metric database 107 and validated mapping database 112. The metric computation system 101 may be implemented as standalone software, or some or all of the components of the metric computation system 101 may be implemented as part of a larger software system, for example a software system for providing financial and accounting services to a user of the user device.

The software implementing the metric computation system 101 implements a web application which serves web data to the metric computation system 101 which as described above enables the user of the metric computation system 101 to interact with the chatbot interface system 103.

As mentioned above, in certain examples certain functionality associated with the metric computation system 101 may be implemented externally. For example, where components of the metric computation system 101 use an externally implemented LLM, for example an LLM associated with the AI system 109, as shown in FIG. 6, such external functionality can be hosted on an external computer system 603. In such examples the metric computation system 101 running on the computer system 602 will exchange data with such an external computer system 603 via the data network 601.

As the skilled person will understand, the metric computation system itself 101 can be implemented in various ways. As shown generally in FIG. 6, the system can be hosted remotely via centralised servers, cloud-based infrastructure, or distributed across multiple servers or locations. However, in alternative implementations, the system can be hosted locally on or near the user device itself, or in a hybrid configuration where some components are hosted locally while others are managed remotely.

As the skilled person will understand, the components of the metric computation system 101, namely the chatbot interface system 103; data resource selector module 104; data resource database 105; metric selector module 106; metric database 107; composite query generator 108; AI system 109; output module 110 and deterministic function 111 can be implemented in any suitable way.

As the skilled person will understand, the components of the metric computation system 101, namely the chatbot interface system 103; data resource selector module 104; data resource database 105; metric selector module 106; metric database 107; composite query generator 108; AI system 109; output module 110 and deterministic function 111 can be implemented in any suitable way. In some embodiments, these components can be implemented as separate software modules/functions as indicated in FIG. 1, each having a well-defined interface and input/output parameters. In other embodiments, the functionality performed by these components can be implemented differently, e.g. implemented as parts of other software functions modules, or integrated into a single software module/function. Furthermore, the components can be arranged in different configurations and communicate with each other in various ways, such as via direct or indirect connections, message passing, shared memory, or other suitable mechanisms.

Although the examples above are generally described in terms of generating financial and accounting related metrics from financial and accounting related data resources, the invention is not limited to this setting. The invention can be applied to any setting where there is a need to generate metrics from data resources that are relevant to a user's query or context. For example, the invention can be used in a marketing setting, where the user can ask for metrics such as customer satisfaction, brand awareness, or conversion rate from data resources such as surveys, social media, or web analytics. Alternatively, the invention can be used in a healthcare setting, where the user can ask for metrics such as patient outcomes, quality of care, or cost-effectiveness from data resources such as medical records, clinical trials, or health insurance. Another example of a setting where the invention can be used is education, where the user can ask for metrics such as student performance, learning outcomes, or engagement from data resources such as assessments, curriculum, or feedback. These are just some illustrative examples of how the invention can be used in other settings, and the skilled person will appreciate that the invention can be adapted to any other suitable setting where metrics and data resources are available or can be obtained.

While specific examples of employing large language models (LLMs) and other artificial intelligence technologies have been described herein in relation to various functions of the invention, it should be understood that the scope of the invention is not limited to these examples. Examples of the invention can be used with any suitable type of artificial intelligence technology that may be developed or becomes preferable in the future. This includes, but is not limited to, various forms of machine learning models, neural networks, decision trees, reinforcement learning algorithms, and other AI methodologies that may be used to enhance the effectiveness, efficiency, and functionality of the examples of the invention. The incorporation of such technologies can be adjusted to meet specific performance criteria, regulatory compliance, or technological advancements without departing from the scope of the invention.

All of the features disclosed in this specification (including any accompanying claims, abstract and drawings), and/or all of the steps of any method or process so disclosed, may be combined in any combination, except combinations where at least some of such features and/or steps are mutually exclusive. Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features. The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

It will be appreciated that various embodiments of the present disclosure have been described herein for purposes of illustration, and that various modifications may be made without departing from the scope of the present disclosure. Accordingly, the various embodiments disclosed herein are not intended to be limiting, with the true scope being indicated by the following claims.

1. A computer implemented method of deriving a metric from a data resource, said method comprising:
(a) receiving a first data resource query from a user device;
(b) determining if the first data resource query maps to one or more data resources of a plurality of data resources, and if so
(c) communicating identifiers associated with one or more mapped data resources to the user device;
(d) receiving from the user device a first mapping validation representing a user validation of the mapping of one of the one or more mapped data resources to the first data resource query from a user of the user device;
(e) receiving a second metric query from the user device;
(f) determining if the second metric query maps to a metric from a plurality of metrics, and if so;
(g) communicating an identifier associated with a mapped metric to the user device;
(h) receiving from the user device a second mapping validation representing a validation of the mapping of the mapped metric to the second metric query from a user of the user device;
(i) retrieving the validated mapped data resource;
(j) retrieving metric definition data defining how to compute the validated mapped metric;
(k) generating a composite query comprising the metric definition data and the retrieved data resource and an instruction for an AI model to generate an instruction set for a deterministic function that applies the metric computation to the data resource;
(l) inputting the composite query to the AI model and thereby obtaining the instruction set;
(m) inputting the instruction set to the deterministic function and obtaining an output, and
(n) communicating the output to the user device.

2. A method according to claim 1, wherein step (b) comprises:
generating an embedding of the first data resource query;
determining from a first plurality of embeddings, one or more of the first plurality of embeddings that match the embedding of the first data resource query, each embedding of the first plurality of embeddings derived from one of the plurality of data resources, and
mapping to the first data resource query, one or more data resources of the plurality of data resources from which the one or more embeddings that match the embedding of the first data resource query are derived.

3. A method according to claim 2, wherein step (f) comprises:
generating an embedding of the second metric query;
determining from a second plurality of embeddings, each embedding derived from data associated with a different one of the plurality of metrics, which of the second plurality of embeddings that most closely matches the embedding of the second metric query, and
mapping the second metric query to the metric associated with the data from which the embedding that most closely matches the embedding of the second metric query was derived.

4. A method according to claim 2, where the step of determining one or more of the first plurality of embeddings that match the embedding of the first data resource query comprises:
determining which data-resource embeddings have a degree of similarity with the data-resource query embedding which exceeds a predetermined threshold similarity value, and
matching the corresponding data resources with the first data resource query.

5. A method according to claim 1, further comprising, prior to step (b):
querying a validated mapping database to determine if the validated mapping database contains a record of a previously received data-resource query that matches the first data resource query, and that has previously been mapped to a data resource, and if so:
retrieving the previously mapped data resource for use in step (k).

6. A method according to claim 5, further comprising, prior to step (f):
querying the validated mapping database to determine if the validated mapping database contains a record of a previously received metric query that matches the second metric query, and that has previously been mapped to a metric, and if so:
retrieving metric definition data defining how to compute the previously mapped metric for use in step (k).

7. A method according to claim 1, further comprising, after step (c), writing validated mapping data to a validated mapping database indicative of the mapping of the first data resource query and the data resource.

8. A method according to claim 1, further comprising, after step (f), writing validated mapping data to a validated mapping database indicative of the mapping of the second metric query and the metric.

9. A method according to claim 1, wherein the method further comprises, prior to step (b):
performing a first query qualification process in which the first data resource query is assessed to determine if it contains sufficient detail and clarity for processing, and if not:
communicating a response back to the user device requesting clarification or additional information.

10. A method according to claim 1, wherein the method further comprises, prior to step (f):
performing a metric query qualification process in which the second metric query is assessed to determine if it contains sufficient detail and clarity for processing, and if not:
communicating a response back to the user device requesting clarification or additional information.

11. A method according to claim 1, wherein the instruction set obtained in step (l) comprises computer code that can be executed by a code execution module.

12. A method according to claim 11, wherein the deterministic function is a code execution module that is configured to execute the computer code obtained from the instruction set.

13. A computer system for deriving a metric from a data resource, said system comprising a metric computation system communicatively connected to a user device, said metric computation system configured to:
a) receive a first data resource query from the user device;
b) determine if the first data resource query maps to one or more data resources of a plurality of data resources, and if so
c) communicate identifiers associated with one or more mapped data resources to the user device;
d) receive from the user device a first mapping validation representing a user validation of the mapping of one of the one or more mapped data resources to the first data resource query from a user of the user device;
e) receive a second metric query from the user device;
f) determine if the second metric query maps to a metric from a plurality of metrics, and if so;
g) communicate an identifier associated with a mapped metric to the user device;
h) receive from the user device a second mapping validation representing a validation of the mapping of the mapped metric to the second metric query from a user of the user device;
i) retrieve the validated mapped data resource;
j) retrieve metric definition data defining how to compute the validated mapped metric;
k) generate a composite query comprising the metric definition data and the retrieved data resource and an instruction for an AI model to generate an instruction set for a deterministic function that applies the metric computation to the data resource;
l) input the composite query to the AI model and thereby obtain the instruction set;
m) input the instruction set to the deterministic function and obtain an output, and
n) communicate the output to the user device.

14. A system according to claim 13, wherein to perform step b), the metric computation system is configured to:
generate an embedding of the first data resource query;
determine, from a first plurality of embeddings, one or more of the first plurality of embeddings that match the embedding of the first data resource query, each embedding of the first plurality of embeddings derived from one of the plurality of data resources, and
map to the first data resource query, one or more data resources of the plurality of data resources from which the one or more embeddings that match the embedding of the first data resource query are derived.

15. A system according to claim 14, wherein to perform step (f), the metric computation system is configured to:
generate an embedding of the second metric query;
determine from a second plurality of embeddings, each embedding derived from data associated with a different one of the plurality of metrics, which of the second plurality of embeddings that most closely matches the embedding of the second metric query, and
map the second metric query to the metric associated with the data from which the embedding that most closely matches the embedding of the second metric query was derived.

16. A system according to claim 14, where to determine one or more of the first plurality of embeddings that match the embedding of the first data resource query, the metric computation system is configured to:
determine which data-resource embeddings have a degree of similarity with the data-resource query embedding which exceeds a predetermined threshold similarity value, and
match the corresponding data resources with the first data resource query.

17. A system according to claim 13, wherein, prior to step (b), the metric computation system is configured to:
query a validated mapping database to determine if the validated mapping database contains a record of a previously received data-resource query that matches the first data resource query, and that has previously been mapped to a data resource, and if so:
retrieve the previously mapped data resource for use in step (k).

18. A system according to claim 17, wherein, prior to step (f), the metric computation system is configured to:
query the validated mapping database to determine if the validated mapping database contains a record of a previously received metric query that matches the second metric query, and that has previously been mapped to a metric, and if so:
retrieve metric definition data defining how to compute the previously mapped metric for use in step (k).

19. A system according to claim 13, wherein, after step (c), the metric computation system is configured to:
write validated mapping data to a validated mapping database indicative of the mapping of the first data resource query and the data resource.

20. A system according to claim 13, wherein, after step (f), the metric computation system is configured to:
write validated mapping data to a validated mapping database indicative of the mapping of the second metric query and the metric.

21. A method according to claim 13, wherein, prior to step (b), the metric computation system is configured to:
perform a first query qualification process in which the first data resource query is assessed to determine if it contains sufficient detail and clarity for processing, and if not:
communicate a response back to the user device requesting clarification or additional information.

22. A system according to claim 13, wherein, prior to step (f): the metric computation system is configured to:
perform a metric query qualification process in which the second metric query is assessed to determine if it contains sufficient detail and clarity for processing, and if not:
communicate a response back to the user device requesting clarification or additional information.

23. A system according to claim 13, wherein the instruction set obtained in step (l) comprises computer code that can be executed by a code execution module.

24. A system according to claim 23, wherein the deterministic function is a code execution module that is configured to execute the computer code obtained from the instruction set.
